(19) United States
(12) Patent Application Publication
(10) Pub. No.: US 2024/0185740 A1
(43) Pub. Date: Jun. 6, 2024

(54) SYNTHETIC SELF-ADHESIVE SKIN TISSUE, METHOD OF MAKING SAME AND USES THEREOF FOR MEDICAL TRAINING

(71) Applicant: CAE HEALTHCARE CANADA INC., Saint-Laurent (CA)

(72) Inventors: Mathieu HACALA, Saint-Mathieu-de-Beloeil (CA); Mathieu RUEL, Saint-Mathieu-de-Beloeil (CA); REMI DUBUCQ, Saint-Mathieu-de-Beloeil (CA)

(73) Assignee: CAE HEALTHCARE CANADA INC., Saint-Laurent, QC (CA)

(21) Appl. No.: 18/285,158

(22) PCT Filed: Mar. 30, 2022
(86) PCT No.: PCT/IB2022/052979

§ 371 Date: Sep. 29, 2023

Related U.S. Application Data
(60) Provisional application No. 63/168,350, filed on Mar. 31, 2021.

(51) Int. Cl. G09B 23/30

(52) U.S. Cl. CPC G09B 23/30

(57) ABSTRACT

Described herein is a synthetic skin tissue and methods of forming same. The synthetic skin tissue comprises a lower adhesive surface that is self-adhesive on human skin and an upper training surface preferably displaying a simulated wound. The synthetic skin tissue comprises platinum catalyst silicone, a siloxane polymer silicone, and a low-viscosity deadener. Advantageously the synthetic skin tissue can be applied repeatably on a mannequin, a training phantom and/or a standardized patient's skin. Preferably the synthetic skin tissue possesses desired properties such as elastic, human skin-like texture, paintable, pierceable, suturable, washable, stain-resistant and hypoallergenic, making it a great product for repeated uses in medical training.

### CROSS REFERENCE TO RELATED APPLICATION

The present patent application claims priority to United States patent application U.S. 63/168,350 filed on Mar. 31, 2021, which content is incorporated herein in its entirety.

### FIELD OF THE INVENTION

The invention relates to the field of synthetic tissue, and more particularly to a self-adhesive synthetic tissue simulating mammalian skin for use in medical training.

### BACKGROUND OF THE INVENTION

Medical professionals, including veterinary medical professionals, first responders, paramedics and nurses, to name a few, are required to act with a degree of care and skill. The required degree of skill is typically mastered through education and eventually supervised practice. For many medical tasks, there is a constant desire to improve the degree of skill achieved by the beginning trainee before he/she begins practicing in real-life circumstances, on a living subject.

Synthetic training implements configured to represent a portion of human or animal anatomy such as training phantoms or mannequins can be used by trainees to simulate medical procedures or be used for diagnostic training. While the use of conventional training phantoms has been satisfactory to a certain degree, in many applications the training phantoms are configured with specific predetermined scenarios, offering limited flexibility to their use and restricting the amount of available training cases the trainees can be exposed to, limiting the degree of satisfaction associated to their use.

A significant factor in the degree of satisfaction of a synthetic skin tissue being used for medical training purposes is based on the degree of similarity between the synthetic skin tissue and a corresponding portion of the anatomy, from the point of view of the medical act or medical disorder being diagnosed. If the synthetic skin tissue is applied on a medical phantom or mannequin, for instance, it can be desirable for the synthetic skin tissue to be properly adhered on the surface of the medical phantom or mannequin while further being manipulable by the practitioner, providing the illusion that the synthetic skin tissue forms part of the medical phantom or mannequin's skin.

A realistic simulation of the skin can further include the synthetic skin tissue offering a certain degree of resistance to puncturing, stretching and closing back onto itself, such as human skin would when the synthetic skin tissue receives a needle, for instance. Another significant factor in the overall customer experience is the ability to use the synthetic skin tissue repeatedly, many times, before its degree of similarity begins to be affected. However, other practical considerations such as ease of use, maintenance and cost can also dictate the viability of such training tissue and the overall degree of satisfaction of the client.

Imitating mammalian skin, such as human skin poses numerous challenges because an ideal synthetic skin tissue should possess numerous properties such as being elastic, have a texture comparable to human skin, being paintable and/or colorable, being pierceable, being suturable, being washable, being stain-resistant, being hypoallergenic, etc.

Although the use of silicone polymers have been described such as patent publication US 2018/0186938, there is still a need for improvement, particularly for self-adhesive synthetic tissues having a plurality of the desired properties listed above.

Accordingly there is a need for a self-adhesive synthetic tissue simulating mammalian skin for use in medical training.

There is particularly a need for a synthetic tissue that is self-adhesive and that may be applied and removed repetitively from a mannequin or a standardized patient.

There is particularly a need for a synthetic tissue that provides a realistic 3D display of a wound.

The present invention addresses these needs and other needs as it will be apparent from the review of the disclosure and description of the features of the invention hereinafter.

### BRIEF SUMMARY OF THE INVENTION

According to one aspect, the invention relates to a synthetic skin tissue comprising: a platinum catalyst silicone; a siloxane polymer silicone; and a low-viscosity deadener.

According to another aspect, the invention relates to a synthetic skin tissue comprising: (i) a lower adhesive surface that is self-adhesive on human skin, and wherein the lower adhesive surface is configured for a repeated detachable application on a mannequin or a standardized patient; and (ii) an upper training surface comprising a single-component acetoxy-cure silicone rubber displaying a simulated wound.

According to another aspect, the invention relates to a synthetic skin tissue comprising: a body comprised of a low-viscosity deadener and platinum-cure silicone including a platinum catalyst silicone with between 0.001% and 0.01% weight of a platinum-based catalyst and a siloxane polymer silicone having between 5% and 20% weight of polymethylhydrosiloxane, the platinum catalyst silicone and siloxane polymer silicone of the platinum-cure silicone found in a 1:1 weight ratio with a low-viscosity deadener quantity of between 28% to 38% weight of the platinum-cure silicone, the body having a training surface coated with a single-component acetoxy-cure silicone rubber and an uncoated tacky surface opposite the training surface, wherein during use, the uncovered surface can be removably self-adhered on human skin.

According to another aspect, the invention relates to the use of a synthetic skin tissue as defined herein for simulating a wound or medical condition on a mannequin or a standardized patient.

According to another aspect, the invention relates to a method for simulating a mammalian skin condition, comprising applying a synthetic skin tissue as defined herein to a mannequin or a standardized patient.

According to another aspect, the invention relates to a kit for simulating at least one wound, the kit comprising a plurality of sticky wounds, each sticky wound comprising a synthetic skin tissue as defined herein.

According to another aspect, the invention relates to a method of forming a synthetic skin tissue, the method comprising:
providing a platinum catalyst silicone having between 0.001% and 0.01% weight of a platinum-based catalyst;
providing a siloxane polymer silicone having between 5% and 20% weight of polymethylhydrosiloxane;
providing a low-viscosity deadener;
mixing the platinum catalyst silicone, the siloxane polymer silicone and the low-viscosity deadener, the platinum catalyst silicone and the siloxane polymer silicone being in a 1:1 weight ratio, the low-viscosity deadener being in a quantity of between 28% to 38% weight of the combined weight of the platinum catalyst silicone and siloxane polymer silicone, thereby forming a mixture;
pouring the mixture into a mold;
curing the mixture, forming the synthetic skin tissue; and
removing the synthetic skin tissue from the mold,
wherein no more than 15 minutes separates the mixing step and the pouring step.

According to another aspect, the invention relates to a kit for the manufacture of a synthetic skin tissue, comprising: a platinum catalyst silicone comprising a platinum-based catalyst; a siloxane polymer silicone comprising polymethylhydrosiloxane; and instructions for mixing the platinum catalyst silicone and siloxane polymer silicone in a proper ratio for the manufacture of a said synthetic skin tissue.

Additional aspects, advantages and features of the present invention will become more apparent upon reading of the following non-restrictive description of preferred embodiments which are exemplary and should not be interpreted as limiting the scope of the invention.

### BRIEF DESCRIPTION OF THE FIGURES

For the invention to be readily understood, embodiments of the invention are illustrated by way of example in the accompanying figures.

FIG. 1 is an annotated picture showing an oblique view a synthetic skin tissue simulating a swelling condition on a foot, in accordance with one particular embodiment.

FIG. 2 is an annotated picture showing a top view of a synthetic skin tissue simulating a skin cut, in accordance with one particular embodiment.

FIG. 3 is an annotated picture showing a top view of synthetic skin tissues simulating six (6) different types of wounds, in accordance with particular embodiments.

FIGS. 4A and 4B are annotated pictures showing peeling off of a synthetic skin tissue simulating a deep wound on a human forearm, in accordance with one particular embodiment.

FIG. 5 is a flowchart of a method of forming a synthetic tissue, in accordance with one particular example.

FIG. 6 is a schematic showing the steps of forming the synthetic tissue, in accordance with the method of FIG. 5.

FIG. 7 is a flowchart of a method of finishing the synthetic tissue, in accordance with one particular example.

FIG. 8 is a flowchart showing the steps of finishing the synthetic tissue, in accordance with the method of FIG. 7.

FIG. 9 is a flowchart of a method of verifying and cleaning the upper surface of the synthetic tissue before proceeding to finishing steps.

Further details of the invention and its advantages will be apparent from the detailed description included below.

### DETAILED DESCRIPTION OF EMBODIMENTS

In the following description of the embodiments, references to the accompanying figures are illustrations of an example by which the invention may be practised. It will be understood that other embodiments may be made without departing from the scope of the invention disclosed. Unless defined otherwise, all technical and scientific terms used herein have the same meaning as commonly understood by one of ordinary skill in the art to which the invention belongs.

### Synthetic Skin Tissue

One aspect of the invention relates to a self-adhesive synthetic tissue simulating mammalian skin.

In accordance with one embodiment, the synthetic skin tissue comprises a lower adhesive surface and an upper surface opposite to the lower surface. The lower surface is self-adhesive on human skin, as well as silicones and plastic materials of training phantoms, mannequins and the like, and it is configured for repeated detachable application on a mannequin/phantom or a standardized patient's skin. On the other end, the upper training surface is the surface still visible by a user once the lower surface is deposited on a mannequin or a standardized patient's skin. Accordingly the upper training surface is the surface with which a user typically interact, e.g., during medical training. Therefore the upper training surface aims to resemble as much as possible to skin and it also aims to simulate a medical condition (e.g., healthy skin, skin with a pimple, skin with a wound, skin that is swollen, etc.).

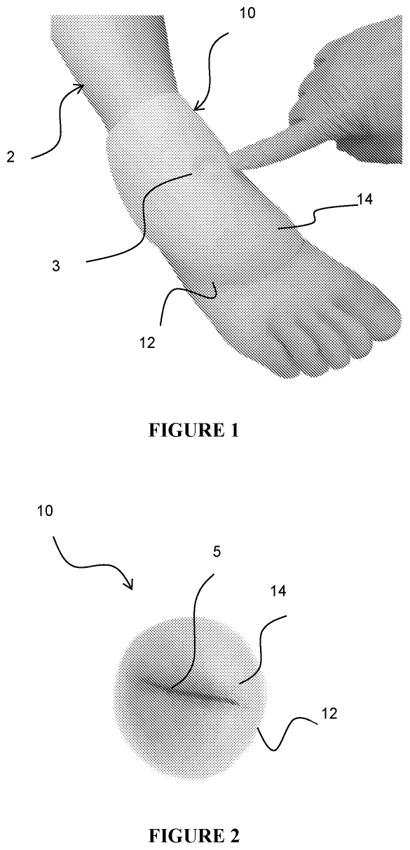

For instance, reference is made to FIG. 1 showing an embodiment of a synthetic skin tissue (10) in accordance with the present invention which is devised to simulate a swelling condition. In this embodiment the synthetic skin tissue (10) comprises a lower adhesive surface (12) which has been deposited on a mannequin's foot (2). The synthetic skin tissue (10) comprises an upper training surface (14) having a color preferably similar to the mannequin's foot (2). In this embodiment, the synthetic skin tissue (10) is also configured (e.g., texture, thickness, elasticity, etc.) such that it mimics a swelling condition such that a user pressing a finger on the upper training surface (4) leaves a temporary spot resembling a pitting edema (3). However, the upper training surface is smooth and free of any visible wound, unlike the embodiments comprising wound(s) shown in FIGS. 2 to 4 and described hereinafter.

Reference is now made to FIG. 2 showing another embodiment of a synthetic skin tissue (10) in accordance with the present invention, that embodiment being devised to simulate a skin cut that may be present on any desired position of a body (arm, leg, chest, back, etc.). In this embodiment the synthetic skin tissue (10) also comprises a lower adhesive surface (12) and an upper training surface (14). Here the upper training surface (14) displays resemble a skin cut (5) (e.g., similar texture, thickness, elasticity, etc.). In embodiments such simulated skin cuts may be used for practicing various techniques, such as disinfection of a wound, for application of medicine (ointment, antimicrobials) and/or suture with a thread and needle.

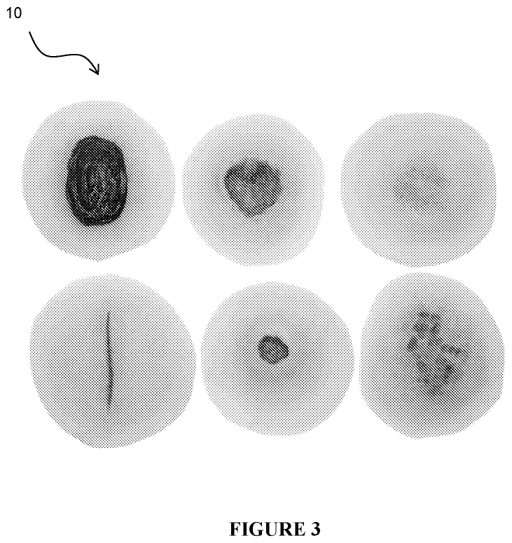

As shown in FIG. 3, the synthetic skin tissue (10) in accordance with the present invention may be manufactured such that the upper training surface (14) displays any desired type of wounds or skin conditions (e.g., a mass, a bump, an uneven elevation, a fake cut, a bruise, a scrape, etc.).

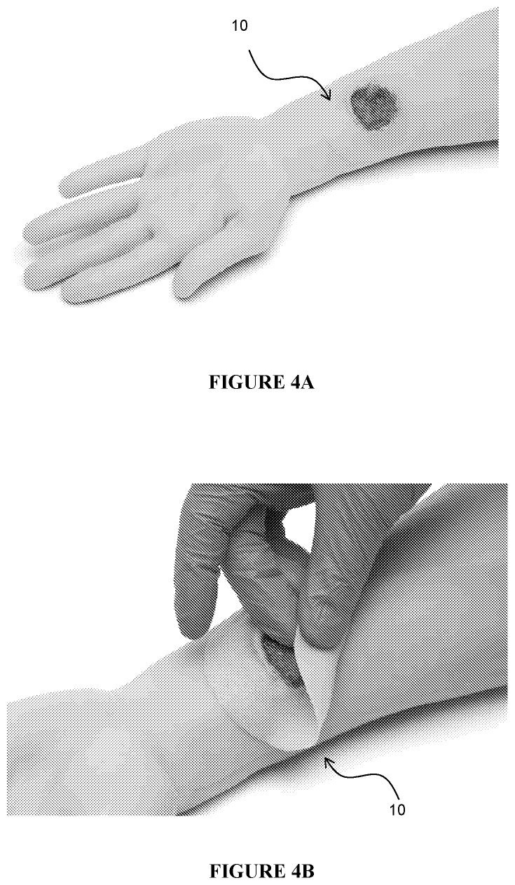

FIGS. 4A and 4B, show a synthetic skin tissue (10) in accordance with the present invention, the synthetic skin tissue (10) displaying a deep wound on a human forearm. Advantageously, the lower surface self-adhesive surface is configured such that the synthetic skin tissue (10) can easily be peeled off repeatedly by a user.

As can be appreciated the synthetic skin tissue in accordance to the present invention preferably displays numerous advantageous features. The presence of one sticky side while the other side (manipulated side) is non-sticky, allow for an easier repetitive handling (i.e. no need for glue). Although the lower adhesive surface has a strong adhesion on almost all types of materials, it leaves no residue on a majority of materials used for mannequins. In the event the lower surface becomes less adhesive is can easily be clean to regain all of its previous adhesive properties. The synthetic skin tissue is also manufactured using a process that merges coloring with molding to increase the durability of the product and its quality because the coloring does not fade or peel off over time. Overall the synthetic skin tissue displays textures of skin and human tissues giving an extraordinary hyperrealism. Accordingly, in accordance with the present invention, the synthetic skin tissue advantageously displays a plurality of the features mentioned hereinabove and it further comprises one or more of the following properties: elastic, human skin-like texture, paintable, pierceable, suturable, washable, stain-resistant and hypoallergenic.

### Composition of the Synthetic Skin Tissue

According to another aspect, the invention relates to a self-adhesive synthetic tissue simulating mammalian skin, the synthetic tissue having a specific and unique composition. Advantageously this composition provides for a end product imitating with great realism mammalian skin, such as human skin, and it further provides a synthetic skin product possessing numerous advantageous properties such as being elastic, having a texture comparable to human skin, being paintable and/or colorable, being pierceable, being suturable, being washable, being stain-resistant, and being hypoallergenic.

In accordance with one embodiment, the synthetic skin tissue comprises a platinum catalyst silicone and a siloxane polymer silicone. In one embodiment the platinum catalyst silicone the siloxane polymer silicone are present in a weight ratio of about 1:1.

In one embodiment the platinum catalyst silicone comprises about 0.001% weight to about 0.01% weight of a platinum-based catalyst. In one embodiment the siloxane polymer silicone comprises about 5% weight to about 20% weight of polymethylhydrosiloxane.

The synthetic skin tissue also comprises a low-viscosity deadener. In embodiments, the low-viscosity deadener represents about 28% weight to about 38% weight, or about 30% weight to about 36% weight, or about 32% weight to about 34% weight, or about 33% weight, of the combined weight of the platinum catalyst silicone and siloxane polymer silicone.

In embodiments, the platinum catalyst silicone is comprised of about 25% weight to about 30% weight of fumed silica, about 50% weight to about 70% weight vinyl silicone oil and about 0% weight and 20% weight hydrogen silicone oil.

In embodiments, the siloxane polymer silicone is comprised of about 25% weight to 30% about weight of fumed silica, about 50% weight to about 70% weight vinyl silicone oil and about 0% weight and 20% weight hydrogen silicone oil.

According to one particular embodiment, the synthetic tissue comprises a low-viscosity deadener and a platinum-cure silicone including a platinum catalyst silicone with between 0.001% and 0.01% weight of a platinum-based catalyst, and a siloxane polymer silicone having between 5% and 20% weight of polymethylhydrosiloxane found in a 1:1 weight ratio, and mixed with a low-viscosity deadener quantity of between 28% to 38% weight of the platinum-cure silicone, the resulting product having an uncoated tacky surface that, during use, can be removably self-adhered on human skin, and that could be useful in increasing the degree of overall customer satisfaction.

As indicated hereinbefore, the synthetic skin tissue may comprise an upper surface displaying a simulated wound (e.g., a bump, an uneven elevation, a fake cut, and a fake mass, etc.). In embodiments, the simulated wound is integral to the synthetic tissue. In embodiments, the simulated wound comprises single-component acetoxy-cure silicone rubber. In one particular embodiment, the simulated wound is composed of a single-component acetoxy-cure silicone rubber which has been fused to the upper surface of the synthetic tissue to form a single entity with the synthetic tissue.

### Kits and Methods of Uses

Synthetic skin tissues in accordance with the present invention find numerous applications, particularly for simulating a portion of mammalian anatomy for medical training or else.

Accordingly, another aspect of the invention relates to the use of a synthetic skin tissue as defined herein for simulating a wound or medical condition on a mannequin or a standardized patient.

A related aspect concerns the synthetic skin tissue as defined herein for application to a mannequin or a standardized patient.

Another related aspect concerns a method for simulating a portion of a mammalian anatomy, comprising applying a synthetic skin tissue as defined herein to a mannequin or a standardized patient. In embodiments the applying comprises depositing the lower adhesive surface of the synthetic skin tissue on the mannequin and/or a patient's skin. In embodiments the synthetic skin tissue is applied and removed repeatedly from the mannequin or a standardized patient. In embodiments the synthetic skin tissue displays a simulated wound such as a bump, an uneven elevation, a fake cut, and a fake mass, etc. and the applying comprises selecting a wound according to a desired simulated wound.

A synthetic skin tissue as defined herein may advantageously be part of a kit. Accordingly, another aspect of the invention concerns a kit for simulating at least one wound (e.g., a bump, an uneven elevation, a fake cut, and a fake mass, etc.), the kit comprising a plurality of sticky wounds each comprising a synthetic skin tissue as defined herein. The kit may further comprise at least one of a mannequin, a training phantom and a body part thereof.

A kit in accordance with the present invention may be configured for different purposes. For instance, the kit may be a suture practice kit, e.g., a for medical student, suture training and comprises a plurality of pre-cut wounds, suture tools, suture thread, needles, etc.

Although the present synthetic skin tissue has been conceived for applications in the field of medical training, it could also be useful for other applications (e.g., making make-up or prosthesis for actors, making of Halloween costumes or masks, etc.)

### Methods of Forming

Any suitable method and technique can be use for forming a synthetic skin tissue in accordance with the present invention.

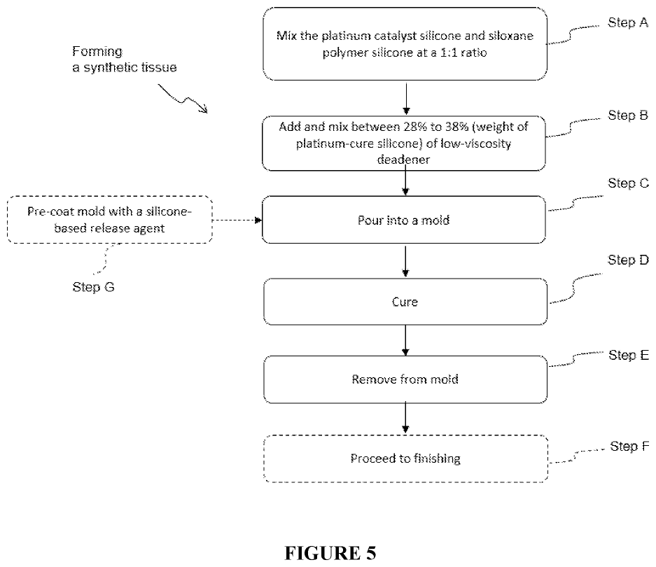

FIG. 5 shows an example method of forming a particular embodiment of a synthetic skin tissue as described herein, e.g. a synthetic skin tissue displaying on its upper surface a wound to be examined and manipulated by a medical trainee, such as synthetic skin tissue as those illustrate in FIGS. 2 and 3.

Referring now to FIG. 5, the example method permits the forming of an example synthetic skin tissue. In this embodiment, the process begins at Step A, by mixing two parts of a platinum-cure silicone in a 1:1 weight ratio, including a platinum catalyst silicone mixture having between 0.001% and 0.01% weight of a platinum-based catalyst and a siloxane polymer silicone mixture having between 5% and 20% weight of polymethylhydrosiloxane. In this particular example, both the platinum catalyst silicone and the siloxane polymer silicone of the platinum-cure silicone have the same basic composition of between 25% to 30% weight of fumed silica, between 50% to 70% weight vinyl silicone oil and between 0% and 20% weight hydrogen silicone oil, with the platinum-based catalyst or the polymethylhydrosiloxane, respectively. It was found that the Inno Silica™ IS-FC05 silicone rubber product provided satisfactory results.

It is understood that the exact composition of the platinum-cure silicone can be altered without departing from the present invention. For instance, in an example embodiment, the quantities of the fumed silica, vinyl silicone oil and/or hydrogen silicone oil can be different for each one of the platinum catalyst silicone and the siloxane polymer silicone. In another embodiment, the quantities of the fumed silica, vinyl silicone oil and/or hydrogen silicone oil can be different for each one of the platinum catalyst silicone and the siloxane polymer silicone, with one of the quantities of the fumed silica, vinyl silicone oil and/or hydrogen silicone oil extending outside the bounds identified above, while providing a platinum-cure silicone with a composition within the bounds identified above. In yet another embodiment, the platinum cure silicone has different additive or is composed of different silicone products, while maintaining platinum catalyst silicone mixture having between 0.001% and 0.01% weight of a platinum-based catalyst and a siloxane polymer silicone mixture having between 5% and 20% weight of polymethylhydrosiloxane.

In certain embodiments, it was found useful to mix the two parts of the platinum-cure silicone, letting it cure and verify that the platinum-cure silicone on itself provided a product having a Shore A hardness of approximately 05 at room temperature before attempting to prepare a synthetic skin tissue using the method of FIG. 5. It was found that providing such a test permitted to verify that the method will ultimately yield a synthetic tissue with the desirable properties, discussed in further detail below. It will be understood that this verification step is entirely optional and can be omitted altogether without departing from the present disclosure.

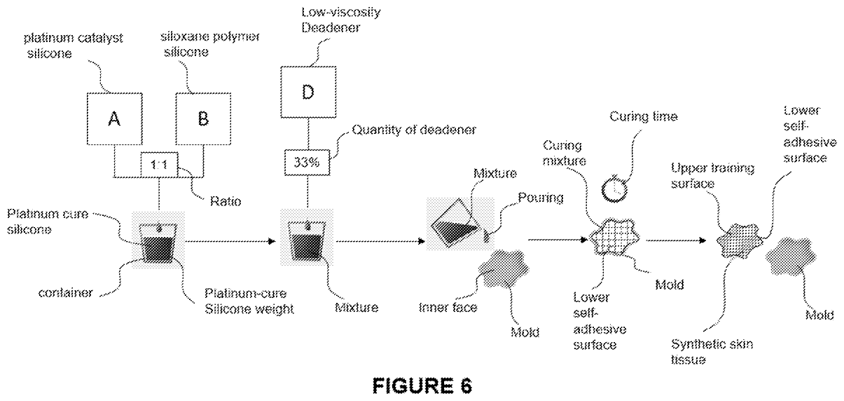

Attention is now brought to FIG. 6 showing a schematic of the steps of forming the synthetic skin tissue in accordance with the method of FIG. 5. The main steps of the method are schematized from the left to right. Step A can be seen on the left-hand side, where the platinum catalyst silicone and the siloxane polymer silicone are mixed at the given 1:1 weight ratio in a container. The container permitting the measurement of the weight of the platinum-cure silicone and the proper mixture of the two parts.

Returning to FIG. 5, once the platinum catalyst silicone and the siloxane polymer silicone are mixed in a 1:1 weight ratio and form a homogenous solution in Step A, a low-viscosity deadener is added and mixed with the solution of Step A, as indicated in Step B. The quantity of low-viscosity deadener added is between about 28% to about 38% weight of the platinum-cure silicone, that is the combined weight of the platinum catalyst silicone and the siloxane polymer silicone. It was determined that a low-viscosity deadener such as the PlatSil™ deadener LV by Polytek™ development corporation provided satisfactory results. However, it will be understood that other deadener products, such as a low-viscosity deadener from a different provider, can be used without departing from the present disclosure. Preferably, the quantity of low-viscosity deadener added is between 30% and 36% weight of the combined weight of the platinum catalyst silicone and siloxane polymer silicone. Even more preferably the quantity of low-viscosity deadener added is between 32% and 34% weight of the combined weight of the platinum catalyst silicone and siloxane polymer silicone. Even more preferably, the quantity of low-viscosity deadener added is approximately 33% weight of the combined weight of the platinum catalyst silicone and siloxane polymer silicone.

Referring to FIG. 6, the addition of the low-viscosity deadener of Step B can be seen. In this particular embodiment, the quantity that is added to the container is 33% weight of the platinum cure silicone, which is within the range identified in Step B.

Returning once again to FIG. 5, the mixed solution at Step B is then poured into a mold in Step C. Step C is completed preferably no more than 15 minutes after the beginning of Step A, in order to ensure proper mixing of the different products and the homogeneous material properties after the curing completed at Step D. In other words, the steps A, B and C are preferably completed within 15-minute window of time. The mold is shaped and dimensioned to correspond to the synthetic skin tissue to be made. In this example, the synthetic skin tissue is much longer and wider than deep such as to form a patch-like synthetic skin tissue, shown in FIGS. 2 and 3. It will be understood, however, that the mold can be of any shape and have any dimensions to form any type of skin tissue structure, or portion thereof, without departing from the present disclosure.

In this particular example, the inner face of the mold has been pre-coated with a silicone-based release agent, as shown in Step G, in parallel to the preparation of the mixture in Steps A and B to be poured in Step C. It was found that the use of a release agent such as Pol-Ease™ 2300 release agent by Polytek™ development corporation provided satisfactory results. It will be understood that other release agents can be used, and that the use of a release agent can be omitted altogether, by using a mold having intrinsic release properties for instance, without departing from the present invention. Further, the coating of the mold, should there be any, can be made at any point in this method without departing from the present disclosure. For instance, in an alternate embodiment, it can be preferable to coat the mold with the release agent before starting step A.

Referring to FIG. 6, the pouring of the mixture into the mold of Step C can be seen. The inner face of the mold having been pre-coated with the silicone-based release agent before pouring.

Returning to FIG. 5, the mixture is then left in the mold to cure at ambient temperature in Step D. In this particular embodiment, and in the formation of a training phantom such is shown in FIGS. 2 and 3, the mold and the mixture are left to cure for at least 30 minutes and preferably approximately 1 hour.

Still referring to Step D of FIG. 5, in this embodiment, the mold has a single inner face which is in contact with the mixture poured therein. The inner face of the mold forms the upper training surface of the synthetic skin tissue once cured, while the surface facing away from the mold, is uncovered and forms the lower self-adhesive surface of the synthetic skin tissue once cured. It will be understood that, based on the complexity of the mold, in alternate embodiments, there can be more than one upper surfaces and self-adhesive surfaces without departing from the present invention. Once the time at Step D has lapsed, the formed synthetic skin tissue is then removed from the mold at Step E. This can be done by simply returning the mold such that the self-adhesive surface faces downwards, for instance, and using gravity to remove the synthetic skin tissue from the mold.

Steps D and E can be seen on the left-hand side of FIG. 6, where the mixture having been poured but not yet cured is shown with a large hash, where the lower self-adhesive surface of the synthetic skin tissue is accessible from the top of the mold, while the upper surface is in contact with the mold. Once the mixture has gone through the curing time, the mixture is cured, shown by a small hashing and synthetic skin tissue is removed from the mold.

Returning to FIG. 5, after Step E, the synthetic skin tissue is cured and can be manipulated by a person. In this particular embodiment, the method and mixture lead to a synthetic skin tissue having at least the lower self-adhesive surface being tacky and capable of sticking on surfaces and, more particularly, being self-adhesive to human skin. It is understood that the synthetic skin tissue can also be considered to be self-adhesive to synthetic materials, such as silicone, plastic, vinyl, etc. that are typically present on training phantoms and mannequins.

It can be desirable for the training surface of the synthetic skin tissue to have other features or a different finish, such as having a different texture, color, shape and/or feel. With reference to the example of FIGS. 2 and 3, it can be desirable for the training surface to be smooth, non-tacky, have a feature and have complementary surface colors mimicking human flesh.

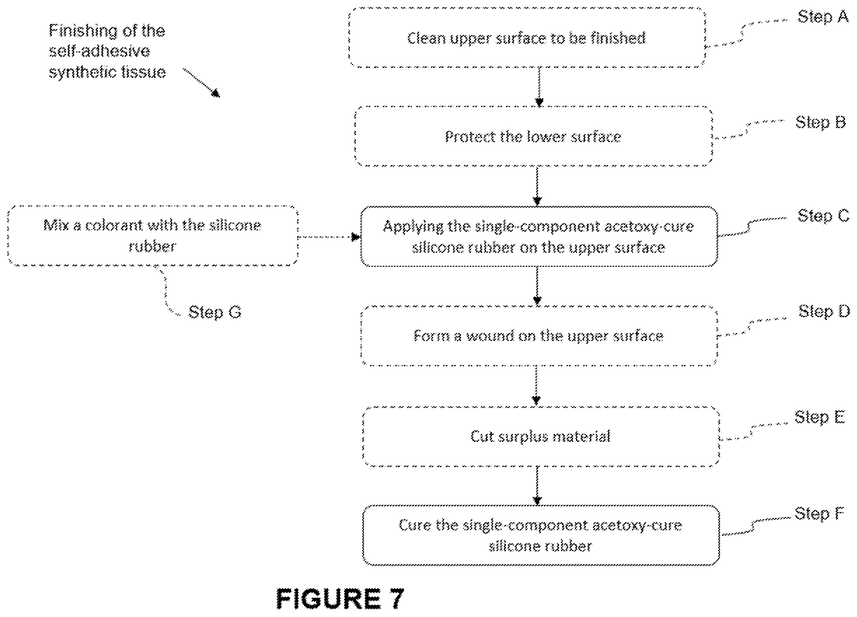

In this particular example, and with reference to FIG. 5, the synthetic skin tissue proceeds to finishing steps, as shown in Step F. Attention is now brought to FIG. 7, showing a flowchart of an example method of finishing the synthetic skin tissue. In this embodiment, the upper training surface of the synthetic skin tissue is the surface to be finished and the method begins by first checking that upper surface to ensure it is clean and that it be cleaned if required, at Step A. It is desirable for the surface to be finished to be clean and free of any debris, dust, or other products which may interfere with the finishing steps. This can be the case, for instance, if a thick layer of the silicone-based release agent is used to coat the mold in step G of FIG. 5. At this stage the of forming the artificial skin tissue the upper training surface should be tacky, unless if it is not clean and in such case it will have lost its tacky properties. Therefore it is desirable to clean the upper surface before finishing.

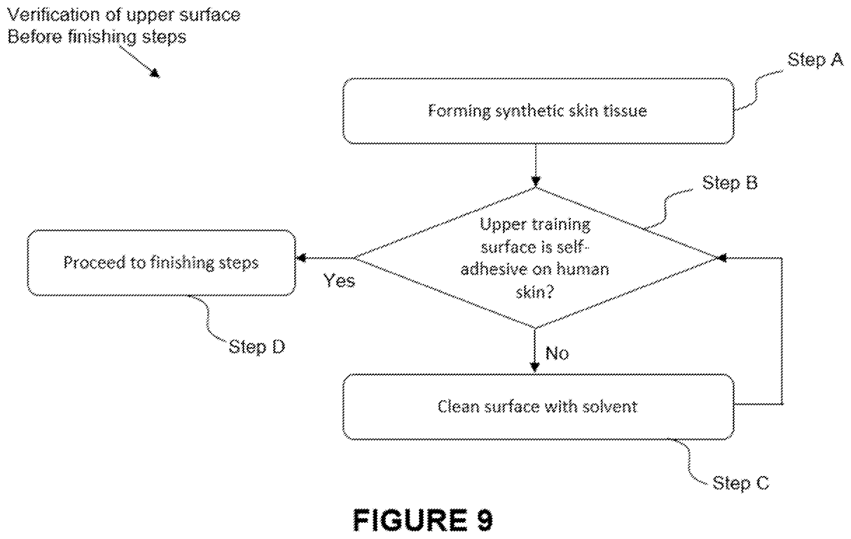

As perhaps best seen in FIG. 9, showing a flowchart of an example method of verifying and cleaning the upper training surface of the synthetic skin tissue before proceeding to succeeding finishing steps, after the forming of the synthetic skin tissue as shown in Step A, the synthetic skin tissue can be verified at Step B. If the surface to be finished, in this particular embodiment being the upper training surface, is not tacky such as to be self-adhesive to human skin, then the training surface is deemed to require cleaning at step C, such as to remove any material adhered to the upper training surface.

At step C, the upper training surface is cleaning by running a solvent on the surface and removing any debris. In this particular example, the solvent is liquid butane, and the cleaning is done by running a stream of butane on the surface. It will be understood, however, that other solvents can be used and that other method of cleaning can be used without departing from the present disclosure. For instance, in an alternate embodiment, the synthetic skin tissue can be temporarily submerged in the solvent and the surface to be cleaned rubbed to remove any debris.

Once cleaning of the upper training surface is done at Step C, one can once more verify that the training surface is self-adhesive on human skin. Should the upper training surface fail once more the verification step B, it can be once again cleaned at step C. The cleaning step C and verification step B can be repeated as many times as required, until the training surface is self-adhesive on human skin, succeeds the verification step B and proceeds for finishing as shown in step D.

Returning to FIG. 7, in this particular embodiment, the upper training surface is cleaned at Step A. Then, the lower self-adhesive surface of the synthetic skin tissue is protected by placing the uncovered surface of the synthetic skin tissue on wax paper. This permits the free manipulation of the synthetic skin tissue and ensures that the following finishing steps do not contaminate the lower self-adhesive surface, thus maintaining its self-adhesive properties.

It will be understood that step A can be omitted in certain embodiments of the present invention, specially in the case in which the forming of the synthetic skin tissue is done in a controlled environment and where the verification and cleaning of the surface is deemed unnecessary. Similarly, Step B can also be altered or omitted without departing from the present invention. For instance, in alternate embodiment, a clean metallic support surface can be used to protect the lower self-adhesive surface of the synthetic skin tissue. In yet another embodiment, the upper training surface is not protected during the finishing steps, being instead received on a user's hand during the finishing steps and simply cleaned by following the steps identified above in relation to FIG. 9 after the finishing steps are completed.

Still referring to FIG. 7, the upper training surface of the synthetic skin tissue receives a layer of a single-component acetoxy-cure silicone rubber, as indicated at Step C. It was determined that a single-component acetoxy-cure silicone rubber meeting ASTM C-920, Type-S, NS, Class 25, Use NT, M, G, A & O test requirements provided satisfactory results. Particularly, it was found that the Tub & Tile, Silicone 1™ product sold by General Electric Company provided satisfactory results.

In this particular embodiment, the single-component acetoxy-cure silicone rubber is first mixed with a colorant or a mix of colorants at Step G, to provide the single-component acetoxy-cure silicone rubber a color representative of human flesh. The single-component acetoxy-cure silicone rubber is then added to a latex-free sponge and is then applied by blotting the upper training surface. It will be understood that the step of adding colorant can be omitted without departing from the present invention. For instance, this can be the case when it is desired to finish the training surface by removing the tackiness of the synthetic tissue, while not altering the color of the training surface. In this case, the use of a transparent single-component acetoxy-cure silicone rubber can be preferred.

It will be understood that the amount of single-component acetoxy-cure silicone rubber and the different mixtures of single-component acetoxy-cure silicone rubber with various colorants can be used to achieve the desired feature and dermatological effect. At Step D, the same single-component acetoxy-cure silicone rubber can be used to created bumps, uneven elevations of the upper training surface, fake cuts, fake masses, fake pimples, and other textures or desired characteristics. For instance, in this embodiment, the wound structure is formed using the single-component acetoxy-cure silicone rubber having a color corresponding to the flesh and is then finished with a single-component acetoxy-cure silicone rubber mixed with a red colorant, such as to form the desired bloody wound seen in the synthetic skin tissue of FIG. 2 or FIG. 4A.

It will be understood that the creation of a wound at Step D is entirely optional and can be omitted without departing from the present. For instance, in an alternate embodiment, the single-component acetoxy-cure silicone rubber is applied to the upper training surface, such as to mimic healthy skin for instance, without having a feature defined. It will further be understood that other materials can be added and combined with the single-component acetoxy-cure silicone rubber to form a wound without departing from the present invention. For instance, in an alternate embodiment, it can be desirable to add a piece of broken glass, or alternatively a piece of clear plastic, resembling broken glass, to the layer of single-component acetoxy-cure silicone rubber, such as to form an object protruding from the synthetic skin tissue. Likewise, in can be envisioned to incorporate natural or artificial hair(s) to the artificial skin tissue.

Still referring to FIG. 7, after the application of the single-component acetoxy-cure silicone rubber and the formation of the wound, should there be any, at Steps C and D, any surplus material, or material which is otherwise undesired in the final product of the synthetic skin tissue is cut at Step E. It is understood that Step E can be omitted in circumstances where no such material needs to be removed.

Following this, the synthetic skin tissue, and more specifically the single-component acetoxy-cure silicone rubber now forming part of the synthetic skin tissue, is left at room temperature to cure at Step F. In this particular example, the synthetic skin tissue is left to cure at least 1 hour and preferably about 2 hours. It is important to note that during this curing time, the single-component acetoxy-cure silicone rubber becomes fused with the upper surface of the synthetic tissue. Contrary to painting a silicone, the finishes applied to the synthetic skin tissue, such as its colors for instance, are not simply adhered to the upper surface but are in fact bonded or fused with the upper surface of the synthetic skin tissue. The single-component acetoxy-cure silicone rubber becomes part of or integral to the synthetic skin tissue when cured.

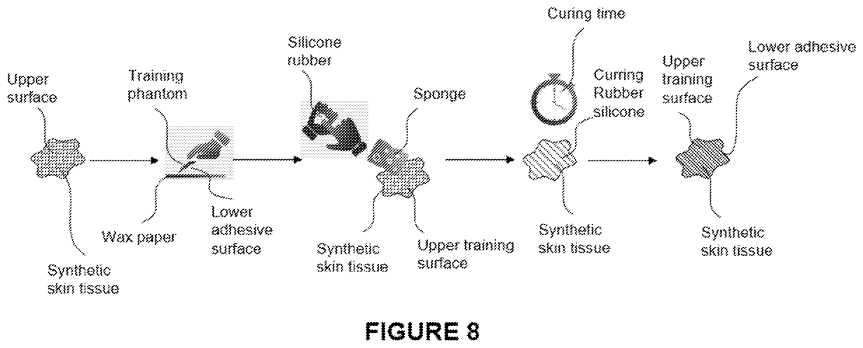

Attention is now brought to FIG. 8 showing a schematic of the steps of finishing the synthetic skin tissue in accordance with the method of FIG. 7. The main steps of the method are schematized from the left to right. The synthetic skin tissue having an upper training surface having been cleaned, as identified in Step A of FIG. 7, is shown in the left-hand side. The synthetic skin tissue and more specifically the lower self-adhesive surface of the synthetic skin tissue is then placed on wax paper, with the clean upper training surface facing away from the wax paper, in this case upwards. The lower self-adhesive surface of the synthetic skin tissue being in contact with the wax paper, protected from the following finishing steps as identified at Step B. The rubber silicone then mixed with a colorant, as identified in step G, is applied to the upper training surface of the synthetic skin tissue, while further defining a wound, as identified in Step C and D. The upper training surface, having been covered with the single-component acetoxy-cure silicone rubber (shown by the large diagonal stripes), is then left to cure for approximately 2 hours. The resulting synthetic skin tissue having an upper training surface (shown by small diagonal stripes) with a wound of interest and a lower tacky self-adhesive surface, opposite the upper training surface.

Since it may be advantageous to commercialize components allowing to manufacture synthetic skin tissues in accordance with the present invention, another aspect of the invention concerns kits for the manufacture of synthetic skin tissues as defined herein. In accordance with one embodiment, the kit comprises: (i) platinum catalyst silicone comprising a platinum-based catalyst; (ii) a siloxane polymer silicone comprising polymethylhydrosiloxane; and (iii) instructions for mixing the platinum catalyst silicone and siloxane polymer silicone in a proper ratio for the manufacture of the synthetic skin tissue. The instructions may further comprise information for mixing the platinum catalyst silicone and siloxane polymer silicone with a proper quantity of a low-viscosity deadener. In embodiments the low-viscosity deadener is also part of the kit. The kit may also comprise components for forming a wound on the synthetic skin tissue including, but not limited to, a single-component acetoxy-cure silicone rubber, colorant(s), etc.

As can be understood, the examples described above and illustrated herein are intended to be exemplary only. Those skilled in the art understands that the methods disclosed herein can be used to make synthetic skin tissues having differing forms and shapes, based on the structure being simulated and the purpose of the training sought, without departing from the present disclosure. Those skilled in the art will recognize, or be able to ascertain, using no more than routine experimentation, numerous equivalents to the specific procedures, embodiments, claims, and examples described herein. Such equivalents are considered to be within the scope of this invention, and covered by the appended claims.

Headings are included herein for reference and to aid in locating certain sections. These headings are not intended to limit the scope of the concepts described therein, and these concepts may have applicability in other sections throughout the entire specification. Thus, the present invention is not intended to be limited to the embodiments shown herein but is to be accorded the widest scope consistent with the principles and novel features disclosed herein.

The singular forms “a”, “an” and “the” include corresponding plural references unless the context clearly dictates otherwise. Thus, for example, reference to “a compound” includes one or more of such compounds and reference to “the method” includes reference to equivalent steps and methods known to those of ordinary skill in the art that could be modified or substituted for the methods described herein.

Unless otherwise indicated, all numbers expressing quantities of ingredients, reaction conditions, concentrations, properties, and so forth used in the specification and claims are to be understood as being modified in all instances by the term “about”. At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the embodiments are approximations, the numerical values set forth in the specific examples are reported as precisely as possible. Any numerical value, however, inherently contains certain errors resulting from variations in experiments, testing measurements, statistical analyses and such.

It is understood that the examples and embodiments described herein are for illustrative purposes only and that various modifications or changes in light thereof will be suggested to persons skilled in the art and are to be included within the present invention and scope of the appended claims.

1.-17. (canceled)

18. A synthetic skin tissue comprising:
a lower adhesive surface that is self-adhesive on human skin, and wherein the lower adhesive surface is configured for a repeated detachable application on a mannequin or a standardized patient; and
an upper training surface comprising a single-component acetoxy-cure silicone rubber displaying a simulated wound;
wherein said synthetic skin tissue is composed of a platinum catalyst silicon, a siloxane polymer silicone, and a low-viscosity deadener; and
wherein the low-viscosity deadener represents about 28% weight to about 38% weight of the combined weight of the platinum catalyst silicone and siloxane polymer silicone.

19. (canceled)

20. The synthetic skin tissue of claim 18, wherein the platinum catalyst silicone and the siloxane polymer silicone are present in a 1:1 weight ratio.

21. The synthetic skin tissue of claim 18, wherein the platinum catalyst silicone comprises about 0.001% weight to about 0.01% weight of a platinum-based catalyst.

22. The synthetic skin tissue of claim 18, wherein the siloxane polymer silicone comprises about 5% weight to about 20% weight of polymethylhydrosiloxane.

23. The synthetic skin tissue of claim 18, wherein the platinum catalyst silicone is comprised of about 25% weight to about 30% weight of fumed silica, about 50% to about 70% weight vinyl silicone oil and up to about 20% weight hydrogen silicone oil.

24. The synthetic skin tissue of claim 18, wherein the siloxane polymer silicone is comprised of about 25% weight to about 30% weight of fumed silica, about 50% weight to about 70% weight vinyl silicone oil and up to about 20% weight hydrogen silicone oil.

25. (canceled)

26. The synthetic skin tissue of claim 18, wherein said simulated wound comprises at least one of a bump, an uneven elevation, a fake cut, and a fake mass.

27. The synthetic skin tissue of claim 18, wherein said synthetic skin tissue comprises a thickness and/or a texture permitting to simulate swelling of natural skin.

28. The synthetic skin tissue of claim 18, wherein said synthetic skin tissue comprises one or more of the following properties: elastic, human skin-like texture, paintable, pierceable, suturable, washable, stain-resistant and hypoallergenic.

29. The synthetic skin tissue of claim 18, for application to a mannequin or a standardized patient.

30. (canceled)

31.-37. (canceled)

38. A kit for the manufacture of a synthetic skin tissue, comprising:
a platinum catalyst silicone comprising a platinum-based catalyst;
a siloxane polymer silicone comprising polymethylhydrosiloxane;
a low-viscosity deadener; and
instructions for mixing the platinum catalyst silicone, the siloxane polymer silicone and the low-viscosity deadener in a proper ratio for the manufacture of said synthetic skin tissue,
wherein the low-viscosity deadener represents about 28% weight to about 38% weight of the combined weight of the platinum catalyst silicone and siloxane polymer silicone.

39. (canceled)

40. A method of forming a synthetic skin tissue, the method comprising:
providing a platinum catalyst silicone having between 0.001% and 0.01% weight of a platinum-based catalyst;
providing a siloxane polymer silicone having between 5% and 20% weight of polymethylhydrosiloxane;
providing a low-viscosity deadener;
mixing the platinum catalyst silicone, the siloxane polymer silicone and the low-viscosity deadener, the platinum catalyst silicone and the siloxane polymer silicone being in a 1:1 weight ratio, the low-viscosity deadener being in a quantity of between 28% to 38% weight of the combined weight of the platinum catalyst silicone and siloxane polymer silicone, thereby forming a mixture;
pouring the mixture into a mold;
curing the mixture, thereby forming the synthetic skin tissue; and
removing the synthetic skin tissue from the mold,
wherein the pouring step is carried out within 15 minutes of the mixing step.

41.-66. (canceled)
